(19) United States
(12) Patent Application Publication
(10) Pub. No.: US 2018/0208225 A1
(43) Pub. Date: Jul. 26, 2018

(54) CART

(71) Applicant: Unarco Industries LLC, Wagoner, OK (US)

(72) Inventors: Wesley McMurtrey, Bixby, OK (US); Valentin E. Alvarez, Broken Arrow, OK (US); Gregory Alan Cox, Porter, OK (US); Mamie Elizabeth Dayan Vogel, Atlanta, GA (US); Stephen Michael Seymour, Edmond, OK (US); Garrett David Johnson, Oklahoma City, OK (US)

(21) Appl. No.: 15/879,659

(22) Filed: Jan. 25, 2018

Related U.S. Application Data
(60) Provisional application No. 62/511,137, filed on May 25, 2017.
(60) Provisional application No. 62/450,437, filed on Jan. 25, 2017.

(51) Int. Cl. B62B 3/14; B62B 3/02

(52) U.S. Cl. CPC B62B 3/1476; G05D 2201/0216; B62B 3/02; B62B 3/1468

(57) ABSTRACT

A flatbed shopping cart is disclosed that has a frame, a plurality of casters positioned below the frame, a handle, and a tray. The frame may form an outer perimeter of the cart, where the frame has a first side portion, a second side portion, and a central front portion. The frame may further have a first end on the first side portion and a second end on the second side portion, where the first side portion extends from the first end downward and backward along a curved surface before moving forward toward the central front portion, such that the first end of the first side portion is located forward of a connection point of a rear caster, and a portion of the first side portion extends rearward beyond the connection point of the rear caster before curving forward toward the central front portion. The tray may have a nonsymmetrical elongated hexagon shape.

### CROSS-REFERENCE TO RELATED APPLICATIONS

This application claims priority to U.S. Provisional Application No. 62/450,437 filed on Jan. 25, 2017 and U.S. Provisional Application No. 62/511,137 filed on May 25, 2017. The above referenced applications are incorporated by reference in their entirety.

### FIELD OF THE INVENTION

This disclosure relates generally to carts including flatbed carts.

### BACKGROUND

Carts are used in many industries to move and carry items. For example, carts including shopping carts and flatbed carts are used in many retail settings to hold items as a user pushes the cart through the retail setting. Although many carts are known, there may exist a need for improved carts and specifically improved flatbed carts.

### BRIEF SUMMARY

Aspects of this disclosure may relate to a flatbed shopping cart in one embodiment that includes a frame, which forms an outer perimeter of the cart and curves upward at the back of the cart, and a tray having a nonsymmetrical elongated hexagon shape.

Aspects of this disclosure may relate to a flatbed cart comprising a frame having a first side portion, a second side portion, and a central front portion, where the central front portion is positioned between the first side portion and the second side portion. The flatbed cart may also include a tray having an outer frame with a wire mesh between sides of the outer frame, where the outer frame is positioned above an upper edge of the central front portion of the frame, a handle extending between the first side portion and the second side portion opposite the central front portion, where the handle has a portion extending rearward from the frame; a wire mesh basket attached between the first side portion of the frame and the second side portion of the frame, and a caster lift system positioned beneath the tray and extending between the first side portion of the frame and the second side portion of the frame. The caster lift system may include a cart engagement portion and a ramp portion, where the ramp portion angles downward and away from the cart engagement portion. The flatbed cart may further comprise a plurality of casters connected to the frame, where the plurality of casters are positioned below the frame. In addition, the first side portion of the frame and the second side portion of the frame may have the same shape. The frame may further have a first end on the first side portion and a second end on the second side portion, where the first side portion extends from the first end downward and backward along a curved surface before moving forward toward the central front portion. The first end of the first side portion may be located forward of a connection point of a rear caster, and a portion of the first side portion extends rearward beyond the connection point of the rear caster before curving forward toward the central front portion.

Additional aspects of this disclosure may relate to a flatbed cart configured such that when a second cart is pushed into a rear of the flatbed cart, the second cart rides up the ramp portion and the second cart rests on the cart engagement portion such that front casters of the second cart are lifted. In addition, the tray of the flatbed cart may have a nonsymmetrical elongated hexagon shape, where a front portion of the hexagon shape is elongated compared to a back portion of the hexagon shape. The tray may be pivotally engaged with the frame. As another option, the frame of the flatbed cart may be formed of three pieces, where the front central portion is U-shaped.

Yet other aspects of this disclosure may relate to a flatbed cart comprising a frame including a first side portion, a second side portion, and a central front portion, wherein the central front portion positioned between a the first side portion and the second side portion, a tray including an outer frame with a wire mesh between sides of the outer frame, where the outer frame is positioned above an upper edge of the central front portion of the frame, a handle extending between the first side portion and the second side portion opposite the central front portion, where the handle has a portion extending rearward from the frame, and a wire mesh basket attached between the first side portion of the frame and the second side portion of the frame, where the wire mesh basket is attached to the frame using a bracket that includes an L-shaped frame engagement piece with a first wall engaged to the frame and a second wall engaging a basket engagement piece that connects to the wire mesh basket. The first wall may have a curved outer portion. The flatbed cart may also comprise a caster lift system extending between the first side portion of the frame and the second side portion of the frame, where the caster lift system includes a cart engagement portion and a ramp portion, where the ramp portion angles downward and away from the cart engagement portion. In addition, the handle may comprise a primary handle portion, a secondary handle portion, and two connection portions, where the handle is engaged with the frame at the two connection portions. The tray may also have a nonsymmetrical elongated hexagon shape, where a front portion of the hexagon shape is elongated compared to a back portion of the hexagon shape, and where the tray is pivotally engaged with the frame.

Still other aspects of this disclosure may relate to a flatbed cart comprising a frame having a first side portion, a second side portion, and a central front portion, where the central front portion positioned between a the first side portion and the second side portion and where the frame has a first end on the first side portion and a second end on the second side portion such that the first side portion extends from the first end downward and backward along a curved surface before moving forward toward the central front portion. The flatbed cart may also include a tray having an outer frame with a wire mesh between sides of the outer frame, where the tray is pivotally attached to the frame and has a nonsymmetrical elongated hexagon shape, wherein a front portion of the hexagon shape is elongated compared to a back portion of the hexagon shape, a handle extending between the first side portion and the second side portion opposite the central front portion, where the handle has a portion extending rearward from the frame, and a caster lift system extending between the first side portion of the frame and the second side portion of the frame, where the caster lift system includes a cart engagement portion and a ramp portion. The ramp portion may angle downward and away from the cart engagement portion. In addition, the handle may comprise a primary handle portion, a secondary handle portion, and two connection portions, where the handle is engaged with the frame at the two connection portions, and where the secondary handle portion extends rearward from a lower portion of each of the two connecting portions. Lastly, the flatbed cart may further comprise an anti-wear component formed from wire attached to a lower portion of the frame, where the anti-wear component has a portion extending beyond an outer surface of the frame.

### BRIEF DESCRIPTION OF THE DRAWINGS

FIG. 1A is a top perspective view of an exemplary cart according to aspects of this disclosure;

FIG. 1B is a bottom perspective view of an exemplary cart according to aspects of this disclosure;

FIG. 1C is a perspective view of an exemplary frame for a cart according to aspects of this disclosure;

FIG. 1D is a perspective view of an exemplary frame and additional components for a cart according to aspects of this disclosure;

FIG. 1E is a perspective view of an exemplary tray for a cart according to aspects of this disclosure;

FIG. 1F is a perspective view of an exemplary tray for a cart according to aspects of this disclosure;

FIG. 2 is a top view of an exemplary cart according to aspects of this disclosure;

FIG. 3 is a bottom view of an exemplary cart according to aspects of this disclosure;

FIG. 4 is a right side view of an exemplary cart according to aspects of this disclosure;

FIG. 5 is a left side view of an exemplary cart according to aspects of this disclosure;

FIG. 6 is a front view of an exemplary cart according to aspects of this disclosure;

FIG. 7 is a back view of two exemplary carts according to aspects of this disclosure;

FIG. 8 is a perspective view of two exemplary carts nested together according to aspects of this disclosure;

FIG. 9 is a top view of two exemplary carts nested together according to aspects of this disclosure;

FIG. 10 is a bottom view of two exemplary carts nested together according to aspects of this disclosure;

FIG. 11 is a right side view of two exemplary carts nested together according to aspects of this disclosure;

FIG. 12 is a left side view of two exemplary carts nested together according to aspects of this disclosure;

FIG. 13 is a front view of two exemplary carts nested together according to aspects of this disclosure;

FIG. 14 is a back view of two exemplary carts nested together according to aspects of this disclosure.

FIG. 15 is a top perspective view of an exemplary cart according to aspects of this disclosure;

FIG. 16 is a side view of the exemplary cart of FIG. 15 according to aspects of this disclosure;

FIG. 17 is a front view of the exemplary cart of FIG. 15 according to aspects of this disclosure;

FIG. 18 is a back view of the exemplary cart of FIG. 15 according to aspects of this disclosure;

FIG. 19 is a top perspective view of the exemplary cart of FIG. 15 having portions of the cart removed, according to aspects of this disclosure;

FIG. 20A is a perspective view of an exemplary bracket for a cart according to aspects of this disclosure;

FIG. 20B is a side view of the exemplary bracket of FIG. 20A according to aspects of this disclosure;

FIG. 21 is a top perspective view of a portion of the exemplary cart of FIG. 15, according to aspects of this disclosure;

FIG. 22A is a perspective view of a portion of an exemplary cart, according to aspects of this disclosure; and

FIG. 22B is a perspective view of a bracket of an exemplary cart, according to aspects of this disclosure.

### DETAILED DESCRIPTION OF EMBODIMENTS

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Nothing in this specification should be construed as requiring a specific three dimensional orientation of structures in order to fall within the scope of this invention. The reader is advised that the attached drawings are not necessarily drawn to scale.

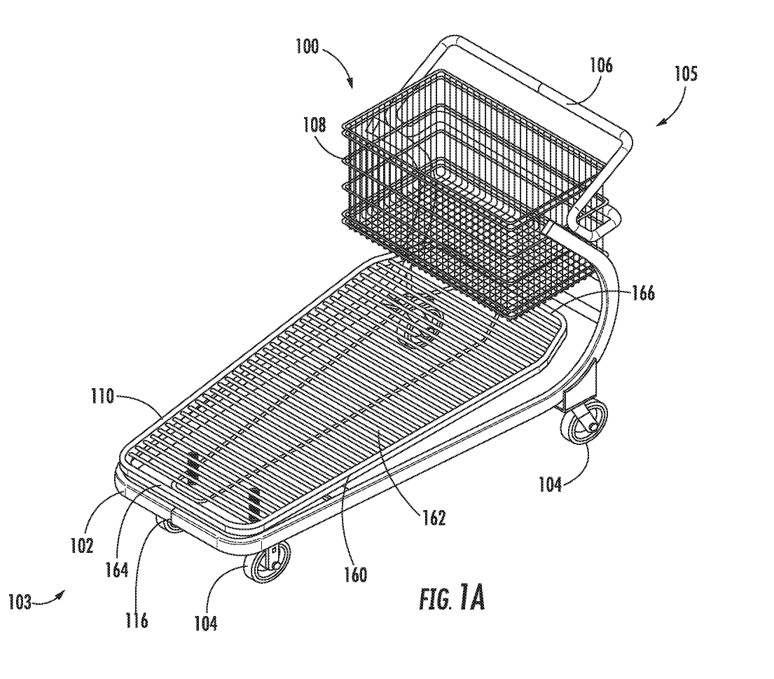

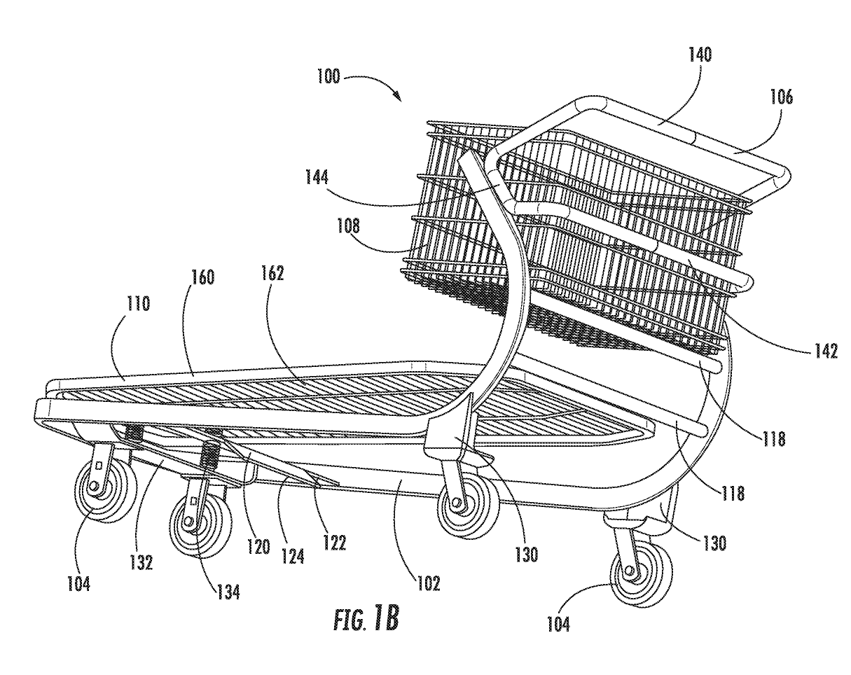

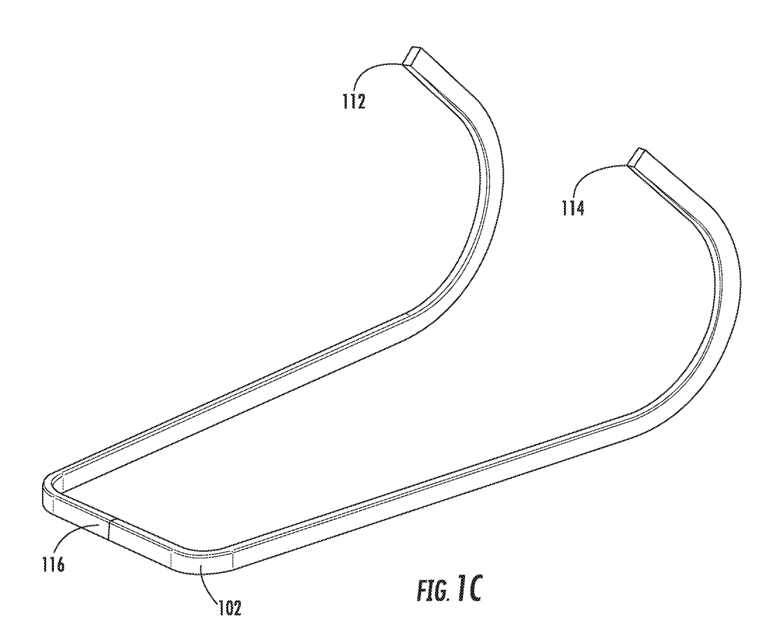

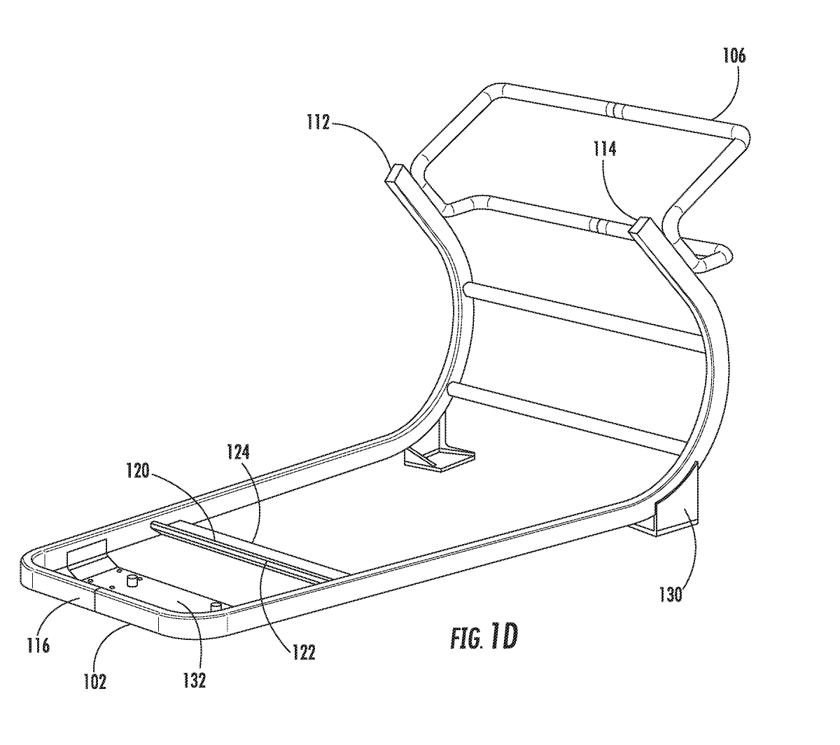

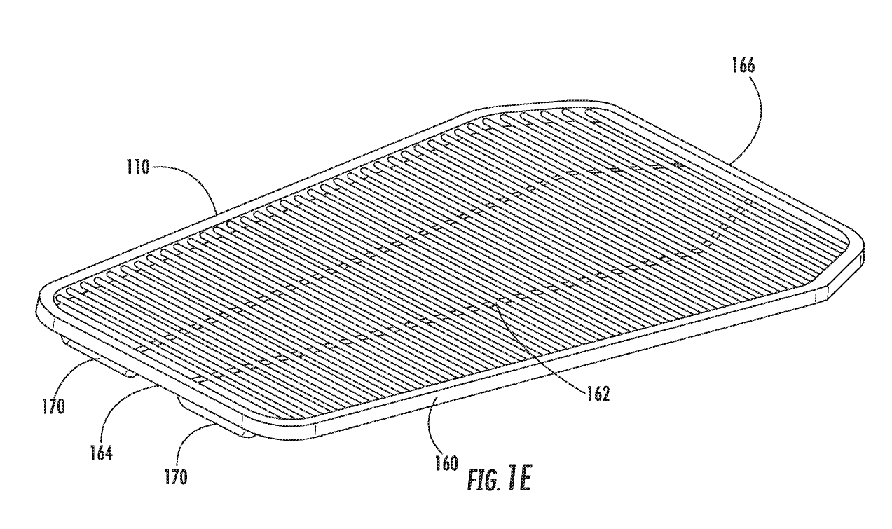

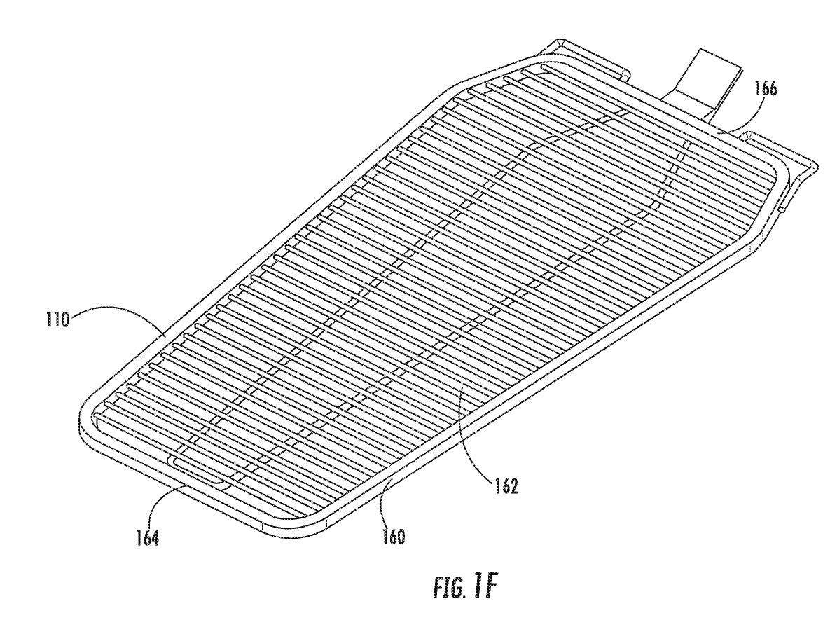

Referring now to the Figures and particularly to FIGS. 1A-1F, a cart 100, often referred to as a flatbed cart, is shown. In some embodiments, and as shown in FIGS. 1A and 1B, an exemplary flatbed cart 100 may have a frame 102, a plurality of casters 104 positioned below the frame 102, a handle 106, a wire mesh basket 108, and a tray 110 along with a front 103 and a rear 105.

As shown in FIGS. 1A-1F the frame 102 may have a first end 112 and a second end 114.

Starting from the first end 112, the first side portion 113 of the frame 102 may curve downward and backward along a curved surface before then beginning to curve forward toward the front 103 of the cart 100. The frame 102 then wraps around the front of the cart 100 while tapering inward. The frame 102 may have a first side portion 113 and a second side portion 115 may have the same shape such that the first side portion 113 is a substantially mirror image of the second side portion 115 ending at the second end 114. As discussed above, the first side portion 113 may begin at the first end 112 located forward of a connection point of the rear caster 104 and then extends rearward beyond the connection point of the rear caster 104 before curving forward toward the front 103 of the cart 100. Similarly, the second side portion 115 may begin at the second end 114 located forward of a connection point 107 of the rear caster 104 to the frame 102 and then extends rearward beyond the connection point 107 of the rear caster 104 to the frame 102 before curving forward toward the front 103 of the cart 100. Additionally, the first side portion 113 and the second side portion 115 of the frame 102 may have a portion with a smooth arcuate shape as the first side portion 113 and the second side portion extend respectively from the first end portion 112 and second end portion 114 to a lower portion of the frame 102. The frame 102 may be formed of a single unitary piece or may be formed of more than one piece connected together. In one embodiment, the frame 102 may be formed of two pieces connected together in a central front portion 116 positioned between the front side portion 113 and the second side portion 115. The two pieces may be connected using welding, mechanical fasteners, press fit, or any other known method. In one embodiment, connecting portions of the frame 102 may include a male end on one side, which may be inserted into an opposite female end on the second side to connect the frame portions together.

In still other embodiments, the frame 102 may be formed of three pieces, a front U-shaped piece 116, and two side pieces 113, 115 which connect to the front U-shaped piece 116. Advantageously, such a three-piece design may allow for modularity of the cart. For example, by adjusting the length of the U-shaped front piece 116, the overall length and/or width of the cart 100 may be adjusted without adjusting the other side pieces of the frame.

The frame 102 may be formed of tubing or other suitable material. The frame 102 may also include one or more strengthening bars 118. The strengthening bars 118 may extend from opposite sides of the frame and may act to strengthen the frame 102 and cart 100. The strengthening bars 118 may be located near the rear 105 of the cart 100, or optionally near the front 103 and rear 105 of the cart 100.

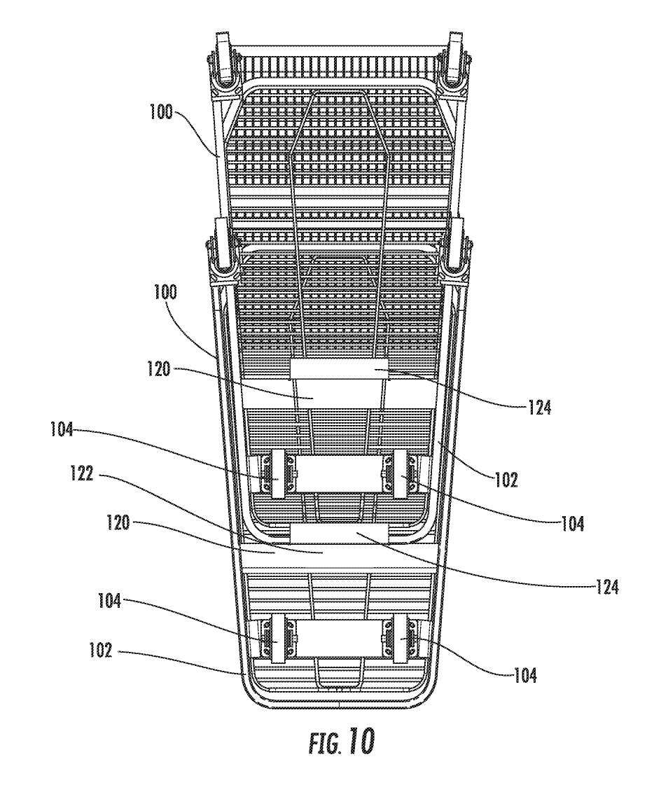

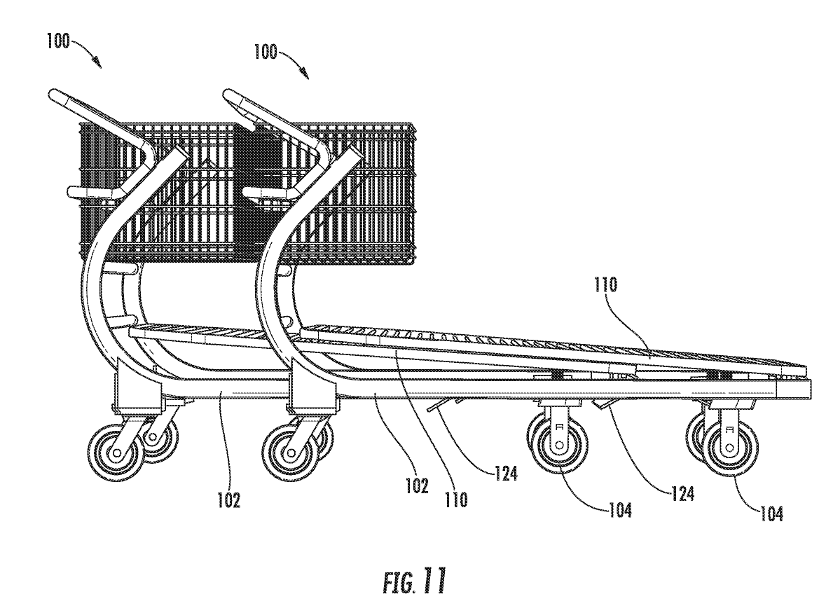

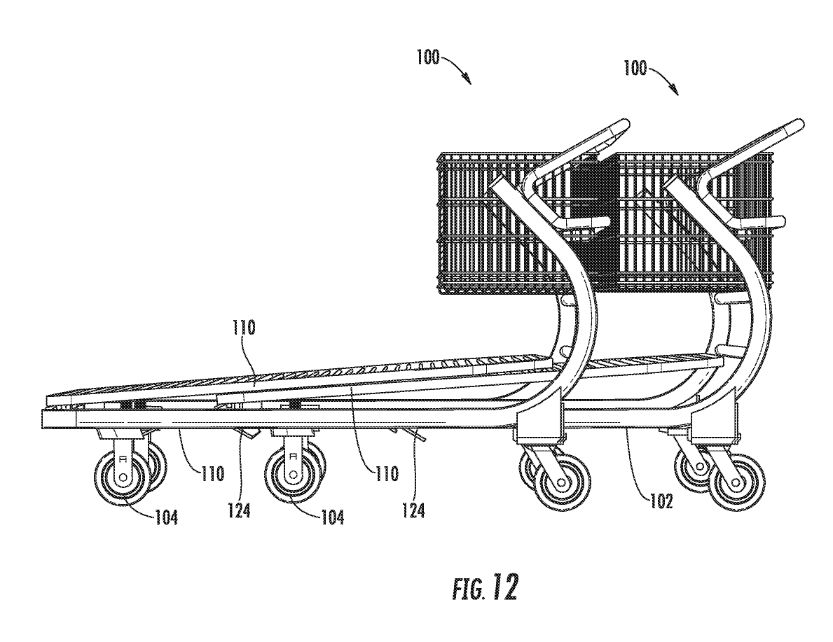

The cart 100 may also include a caster lift system 120. The caster lift system 120 may be engaged with opposite sides of the frame 102 extending between the front side portion 113 and the second side portion 115. The caster lift system 120 may include two portions, a cart engagement portion 122, and a ramp portion 124. As shown, for example, in FIG. 1B, the ramp portion 124 may angle downward and away from the cart engagement portion 122. Advantageously, when a second cart 100 is pushed into the back of a first cart 100, the second cart 100 will ride up the ramp portion 124 of the first cart 100 and the second cart 100 will rest on the cart engagement portion 122 of the first cart 100 such that the front wheels or casters 104 of the second cart 100 are lifted and do not touch the ground. Such a configuration is best shown in FIGS. 11 and 12. Advantageously, this may allow a user to more easily manipulate a plurality of nested carts.

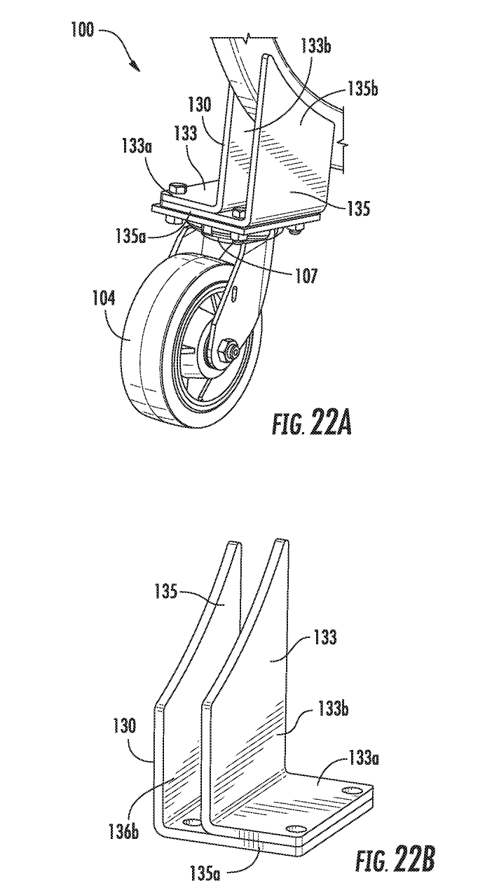

The cart 100 may also include back caster brackets 130, which may be engaged with the frame 102 and the back casters 104. The back caster brackets 130 are shown in more detail in FIGS. 22A and 22B. As shown, the back caster brackets 130 may be comprised of a first, generally L-shaped, inner piece, 133 and a second, generally L-shaped, outer piece 135. As shown in FIG. 22A each of the pieces 133, 135 include a substantially horizontal wall 133a, 135a and a substantially vertical wall 133b, 135b. The horizontal walls 133a, 135a are configured to engage each other and the vertical walls 133b, 135b are configured to engage opposite sides of the frame 102. Advantageously, such a configuration may make it easier and may reduce the number of components typically used in joining the back casters 104 to a cart.

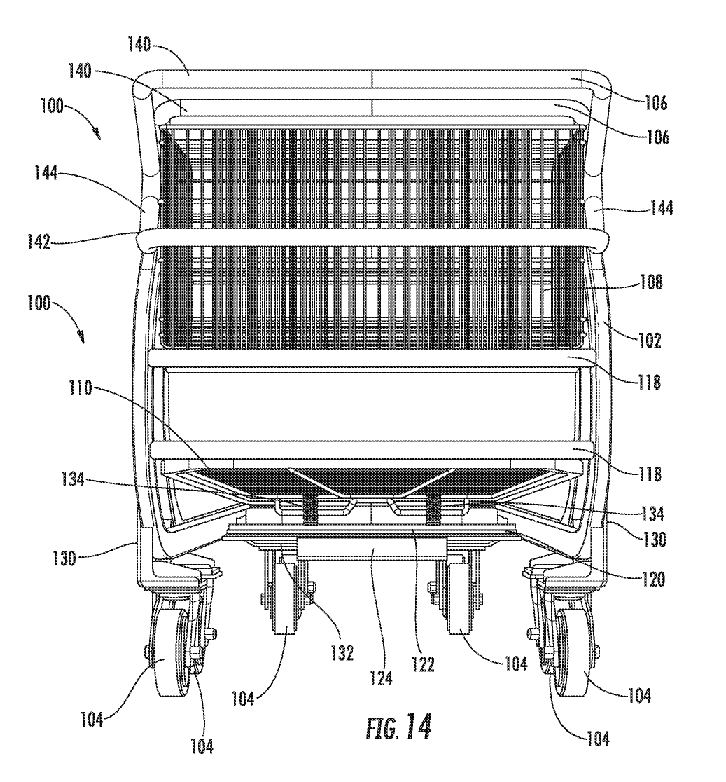

The cart 100 may also include a front caster bracket 132, which may be engaged with opposite sides of the frame 102 and may be engaged with the front casters 104. The front caster bracket 132 may also be engaged with one or more resilient elements such as a spring 134, which may push the tray 110 in an upward position when additional weight is not applied to the tray 110. In other embodiments, the cart may include resilient elements such as a spring 134 additionally or alternatively engaged with the caster lift 120 as shown in FIG. 15.

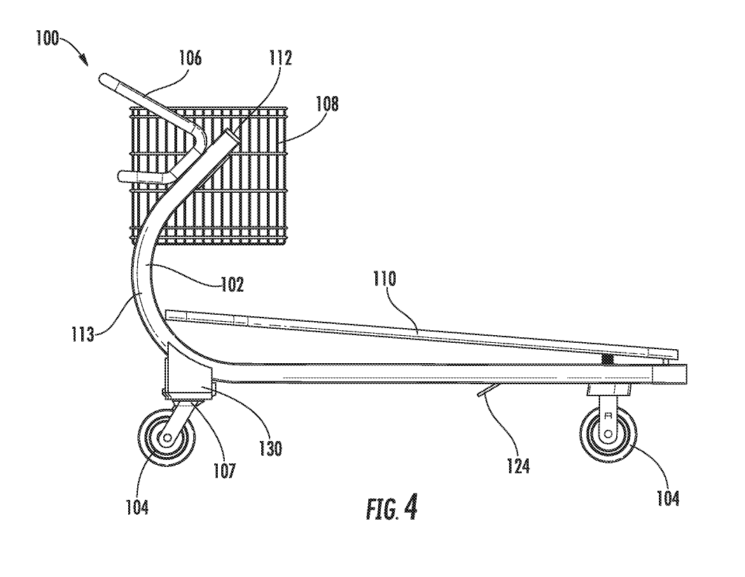

The cart 100 may also include a handle 106 near the rear 105 of the cart 100. The handle 106 may have a primary handle portion 140, a secondary handle portion 142 and two connection portions 144. As shown in the Figures, the handle 106 may be engaged with the frame 102 at the connection portions 144. The handle 106 may be engaged with the frame 102 through welding or otherwise attached through mechanical fasteners such as rivets. As shown in the Figures, the primary handle 140 may extend backward and upward from an upper portion of the connection portions 144 and the secondary handle 142 may extend backward from a lower portion of the connection portions 144. As shown, for example in FIG. 4, the primary handle 140 may extend further backward than the secondary handle 142. Advantageously either of the primary handle 140 or the secondary handle 142 may be used as handles for pushing the cart based on the preference of the user. Additionally, the wire mesh basket 108 may be attached between the first side portion 113 and the second side portion 115 of the frame 102. The secondary handle 142 may act a basket guard to guard the basket 108 from being hit by other carts including standard shopping carts. This may prevent damage to the basket 108 and prolong the life of the cart 100. The handle 106 may be formed of a single piece of tubing that is welded together in one spot. In other embodiments, the handle 106 may be formed of multiple pieces connected together.

The cart 100 may also include a tray 110. The tray 110 may include an outer frame 160 and include a wire mesh 162 between the sides of the outer frame 160. The tray 110 may be positioned above an upper edge of the central front portion 116 of the frame 102. In addition, the tray 110 may have a forward edge that extends beyond the forward edge of the basket 108. In other embodiments, the wire mesh 162 may be replaced with single flat piece of metal or other structure capable of holding items. The tray 110 may have a shape such that it is tapered towards a front portion 164, a back portion 166, or both the front portion 164 and the back portion 166 as shown in the Figures. As shown in the Figures, the tray 110 may have a nonsymmetrical elongated hexagon shape wherein the front portion 164 of the hexagon may be elongated as compared to the back portion 166. Advantageously, this may allow for easier nesting of the carts 100. Near the front 103 of the cart 100, the tray 110 may be pivotally engaged with the frame 102 near the front 103 of the cart 100. In some embodiments, and as shown in FIG. 1E, the tray 110 may be pivotally engaged with the frame 102 using one or more mounting bars 170.

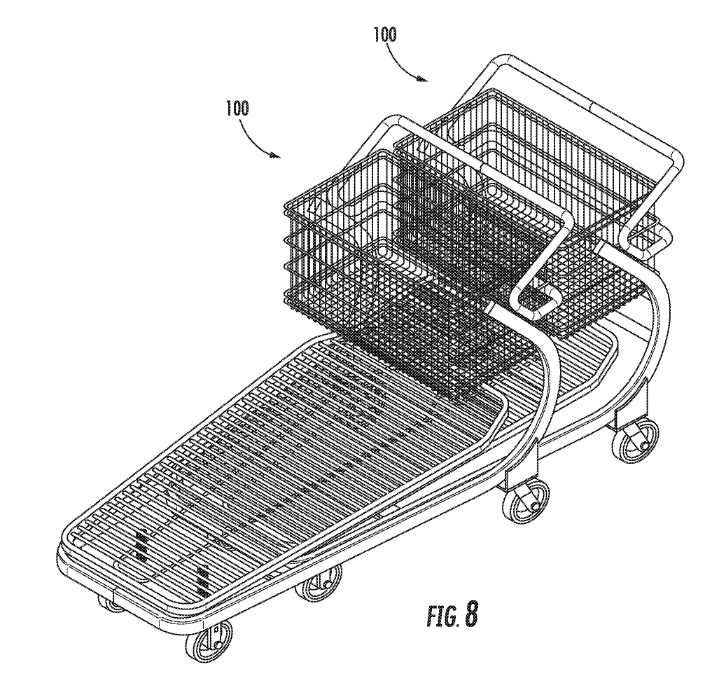

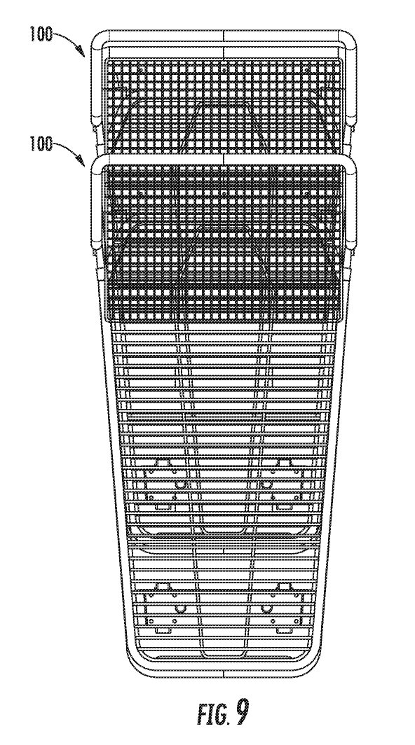

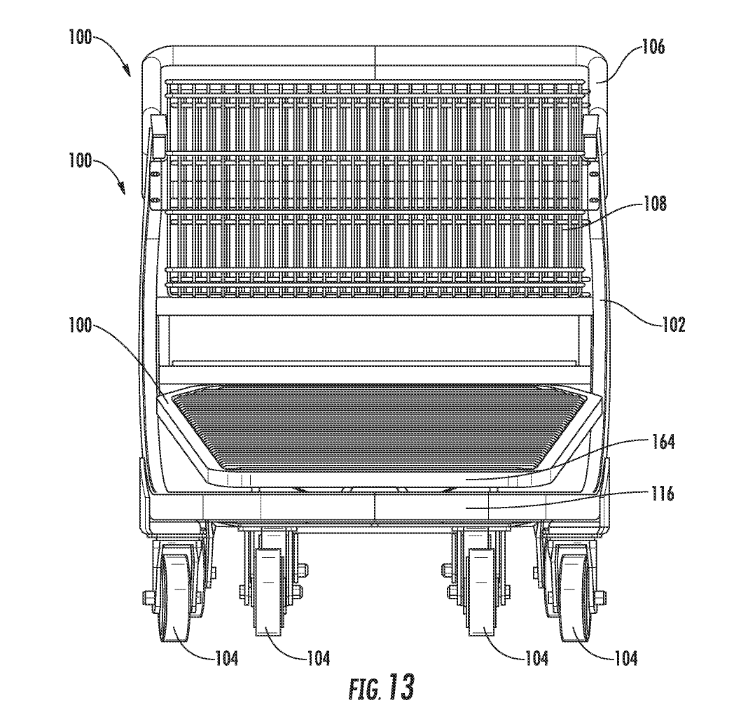

As discussed above, FIGS. 8-14 show two flatbed carts 100 nested together. Although two carts are shown, any plurality of carts 100 may be nested together. As shown in FIGS. 8-14, the carts 100 may nest together such that a front portion of the basket 108 of the back cart may contact the secondary handle 142 of the front cart. Additionally, in other embodiments the basket 108 may be removed from the cart 100 or replaced with another device such as shelf. In such embodiments, the carts may be able to nest closer together.

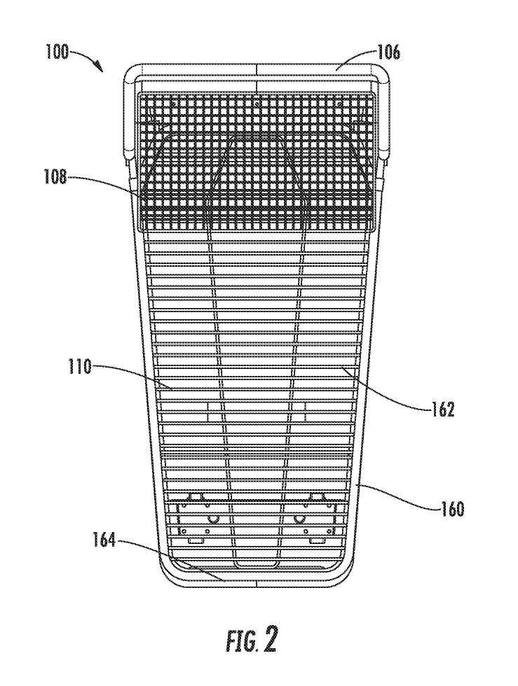

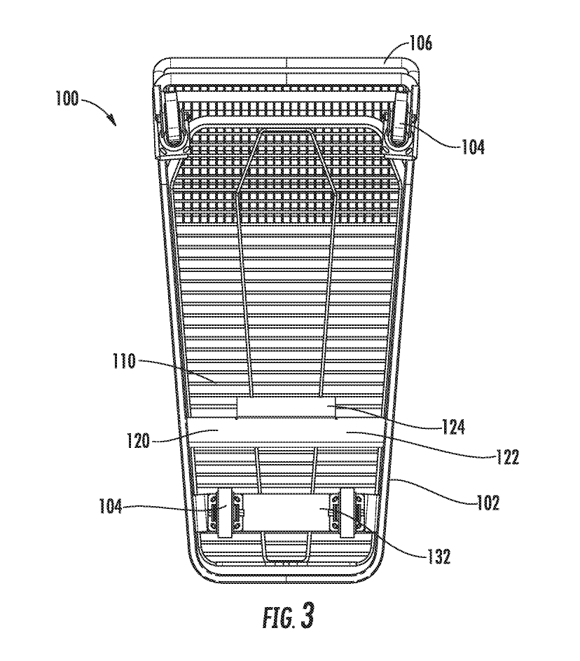

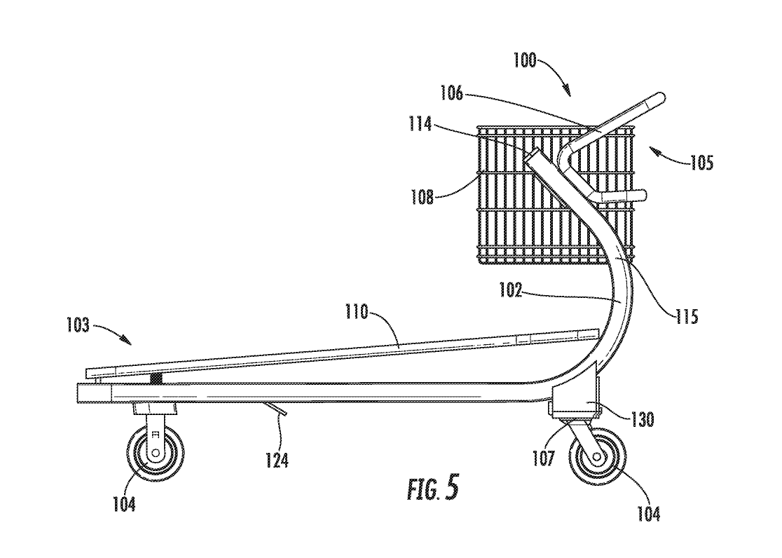

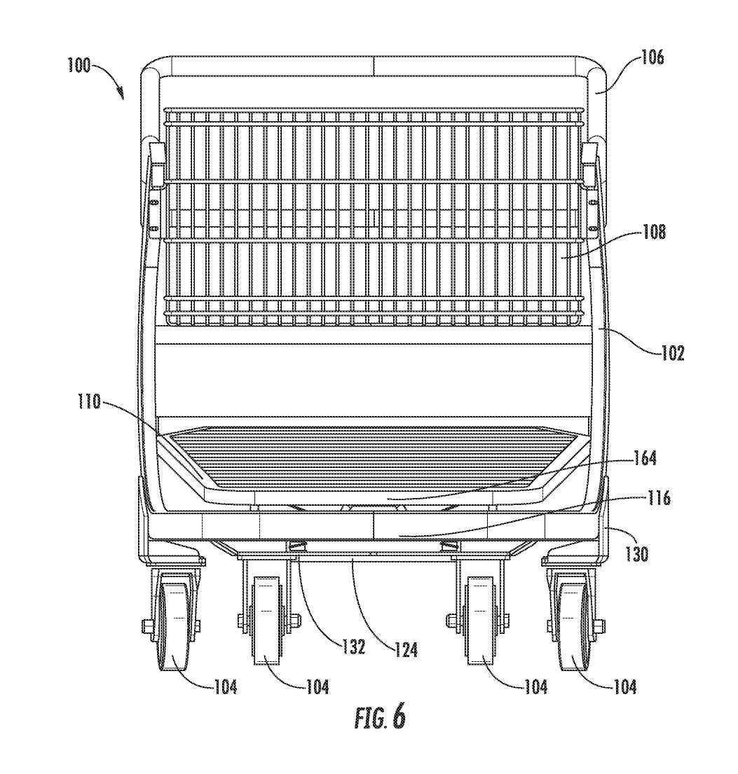

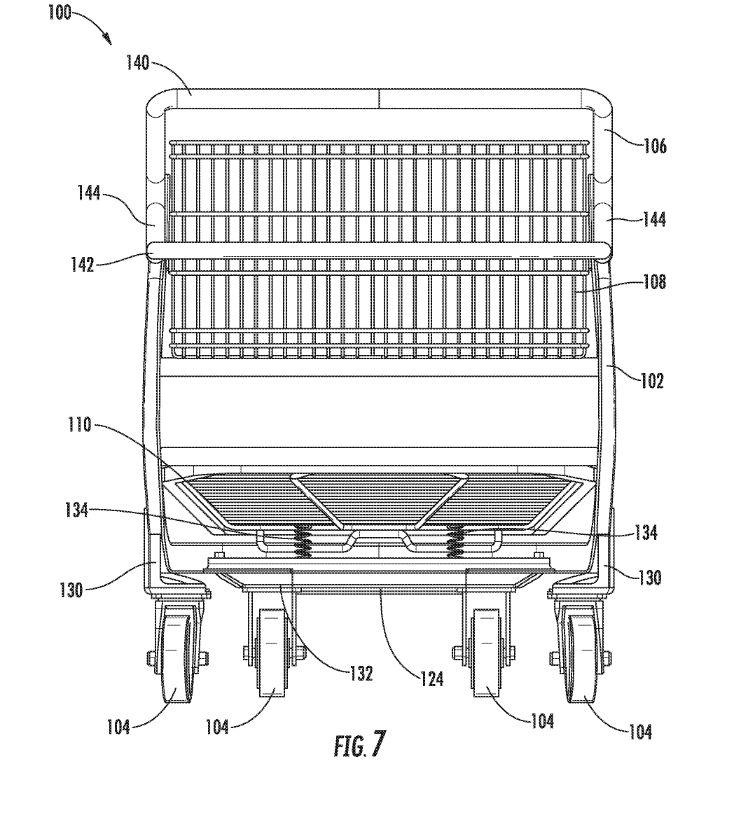

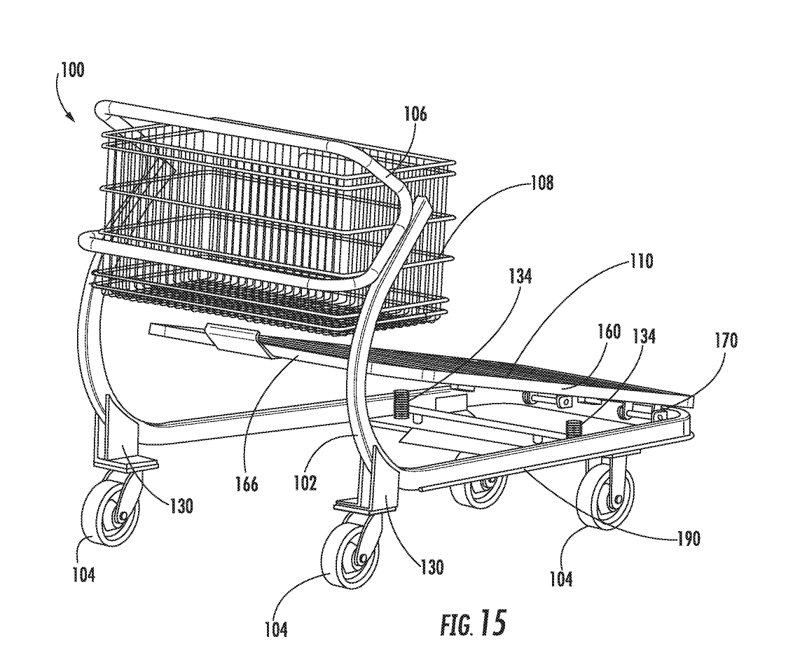

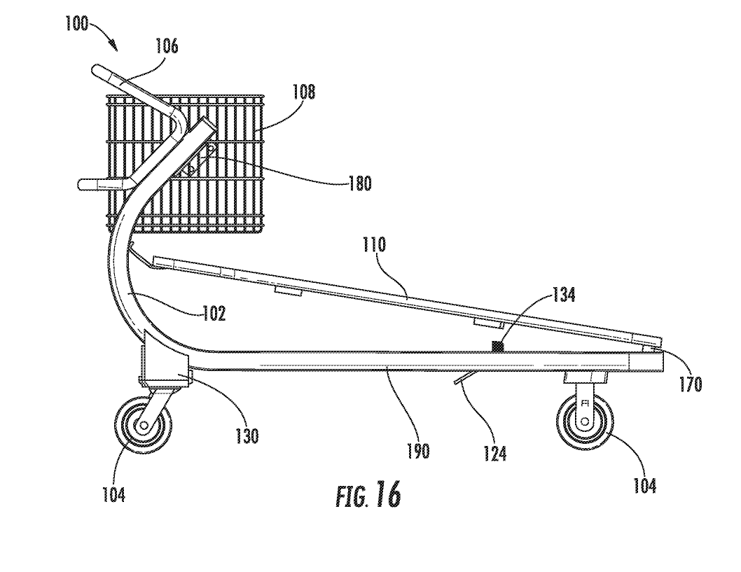

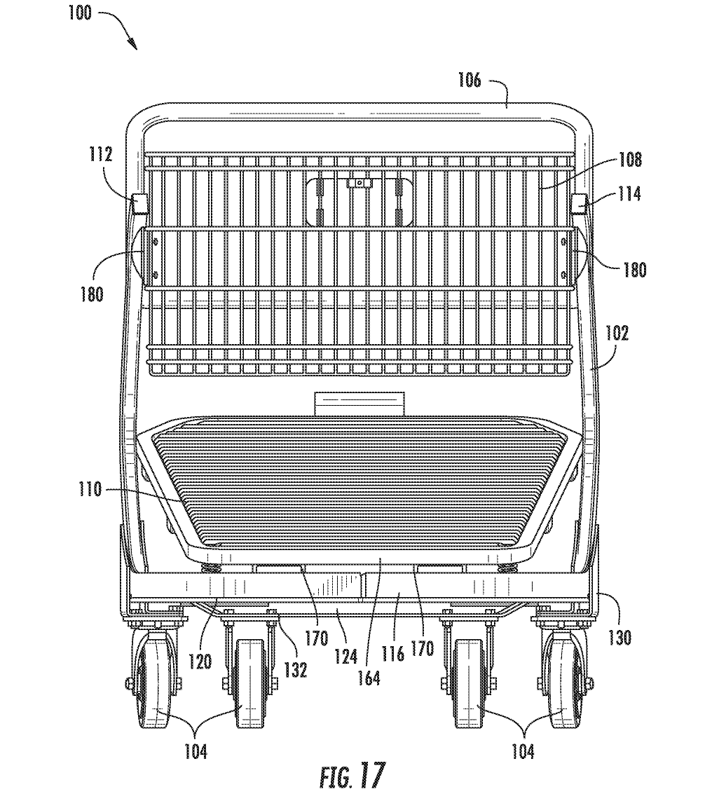

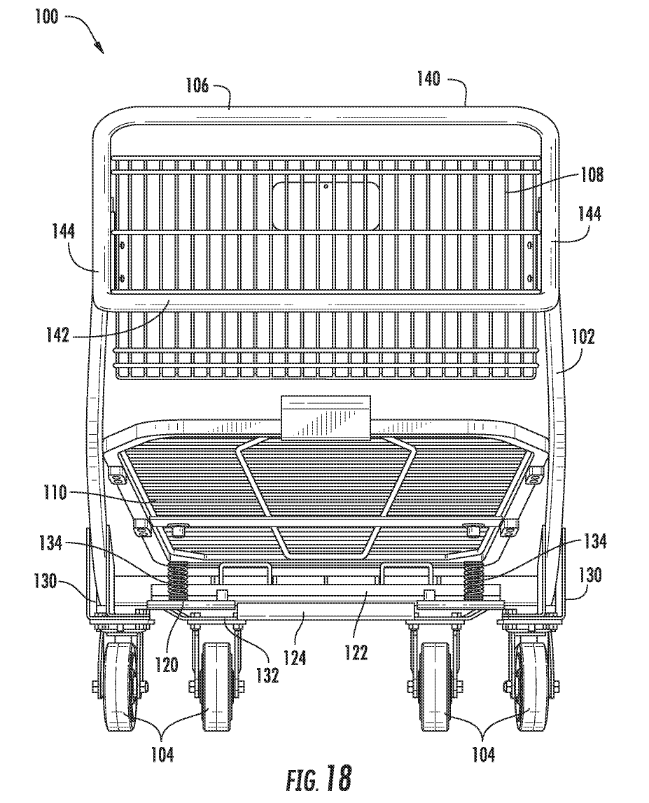

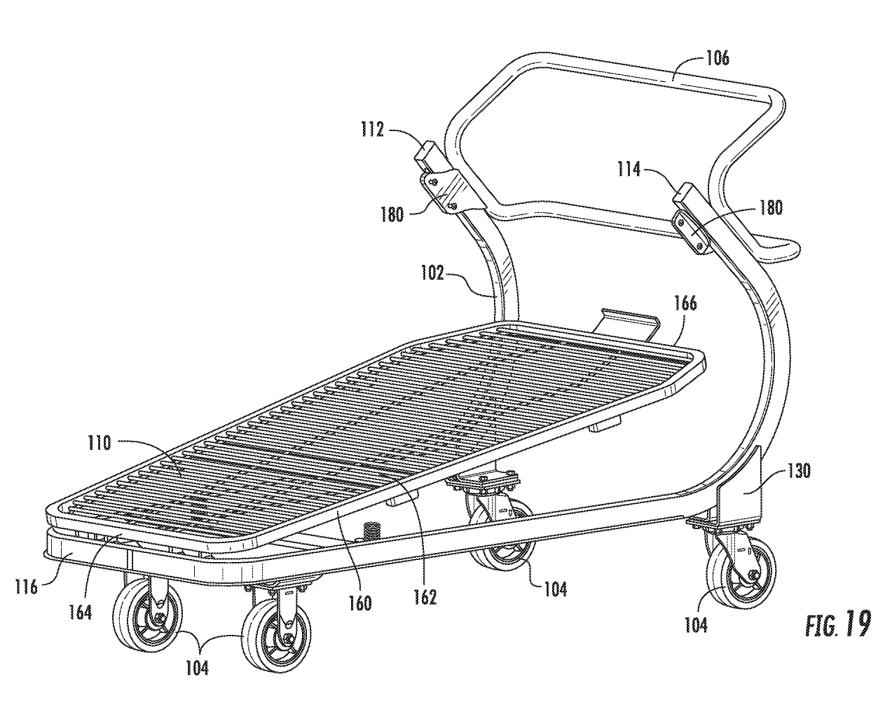

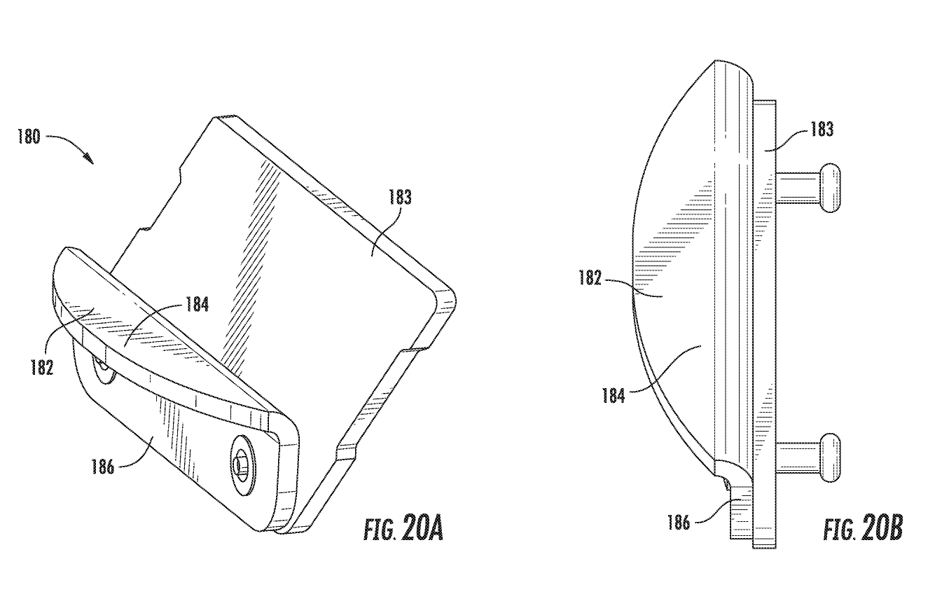

Another cart 100 is shown in FIGS. 15-22 which is substantially similar to the cart 100 shown in FIGS. 1-14. As shown in FIGS. 15-22, the cart 100 may include a bracket used to attach the basket 108 to the frame 102. The bracket 180 may be comprised of a first, generally L-shaped piece, frame engagement piece 182, and a second basket engagement piece 183. The L-shaped piece may have a first wall 184 and a second wall 186. The first wall 184 may engage the frame 102 and the second wall 186 may engage the basket engagement piece 183. As shown best in FIGS. 20A and 20B, the first wall 184 of the bracket 180 may have a curved outer portion. Advantageously the curved outer portion may provide easier mounting of the bracket 180 to the frame 102.

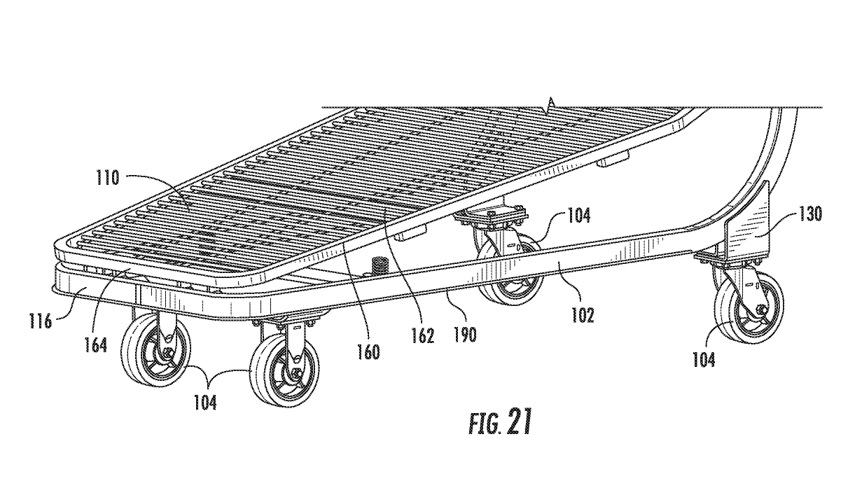

The cart 100 may also include anti-wear feature 190. As best shown in FIGS. 15 and 21 the anti-wear feature 190 may be a piece of wire attached to the frame 102. As shown in FIG. 21 the anti-wear feature 190 may be attached to the lower portion of the frame but it may be attached at any suitable location. As shown, the anti-wear feature 190 may form a bumper attached to the frame 102 and extending beyond an outer surface of the frame 102 over substantially all of the distance of the frame 102 around the lower portion of the frame 102 from the back caster 104 of the first side portion 113 to the back caster 104 of the second side portion 115. Advantageously, the anti-wear feature 190 may reduce paint transfer and may protect the frame 102 when the cart 100 collides with other objects such as other carts or store fixtures.

While various embodiments have been described, it will be apparent to those of ordinary skill in the art that many more embodiments and implementations are possible that are within the scope of the claims. The various dimensions described above are merely exemplary and may be changed as necessary. Accordingly, it will be apparent to those of ordinary skill in the art that many more embodiments and implementations are possible that are within the scope of the claims. Therefore, the embodiments described are only provided to aid in understanding the claims and do not limit the scope of the claims.

What is claimed is:

1. A flatbed cart comprising:
a frame having a first side portion, a second side portion, and a central front portion, wherein the central front portion is positioned between the first side portion and the second side portion;
a tray including an outer frame with a wire mesh between sides of the outer frame, wherein the outer frame is positioned above an upper edge of the central front portion of the frame;
a handle extending between the first side portion and the second side portion opposite the central front portion, wherein the handle has a portion extending rearward from the frame;
a wire mesh basket attached between the first side portion of the frame and the second side portion of the frame; and
a caster lift system positioned beneath the tray and extending between the first side portion of the frame and the second side portion of the frame, wherein the caster lift system includes a cart engagement portion and a ramp portion, wherein the ramp portion angles downward and away from the cart engagement portion.

2. The flatbed cart of claim 1, further comprising a plurality of casters connected to the frame, wherein the plurality of casters are positioned below the frame.

3. The flatbed cart of claim 1, wherein the first side portion of the frame and the second side portion of the frame have the same shape.

4. The flatbed cart of claim 3, wherein the frame has a first end on the first side portion and a second end on the second side portion, wherein the first side portion extends from the first end downward and backward along a curved surface before moving forward toward the central front portion.

5. The flatbed cart of claim 4, wherein the first end of the first side portion is located forward of a connection point of a rear caster, and a portion of the first side portion extends rearward beyond the connection point of the rear caster before curving forward toward the central front portion.

6. The flatbed cart of claim 1, wherein when a second cart is pushed into a rear of the flatbed cart, the second cart rides up the ramp portion and the second cart rests on the cart engagement portion such that front casters of the second cart are lifted.

7. The flatbed cart of claim 1, wherein the tray has a nonsymmetrical elongated hexagon shape, wherein a front portion of the hexagon shape is elongated compared to a back portion of the hexagon shape.

8. The flatbed cart of claim 1, wherein the frame is formed of three pieces and wherein the front central portion is U-shaped.

9. The flatbed cart of claim 1, wherein the tray is pivotally engaged with the frame.

10. A flatbed cart comprising:
a frame including a first side portion, a second side portion, and a central front portion, wherein the central front portion positioned between a the first side portion and the second side portion;
a tray including an outer frame with a wire mesh between sides of the outer frame, wherein the outer frame is positioned above an upper edge of the central front portion of the frame;
a handle extending between the first side portion and the second side portion opposite the central front portion, wherein the handle has a portion extending rearward from the frame; and
a wire mesh basket attached between the first side portion of the frame and the second side portion of the frame, wherein the wire mesh basket is attached to the frame using a bracket that includes an L-shaped frame engagement piece with a first wall engaged to the frame and a second wall engaging a basket engagement piece that connects to the wire mesh basket.

11. The flatbed cart of claim 10, further comprising a caster lift system extending between the first side portion of the frame and the second side portion of the frame, wherein the caster lift system includes a cart engagement portion and a ramp portion, wherein the ramp portion angles downward and away from the cart engagement portion.

12. The flatbed cart of claim 10, wherein the handle comprises a primary handle portion, a secondary handle portion, and two connection portions, wherein the handle is engaged with the frame at the two connection portions.

13. The flatbed cart of claim 10, wherein the tray has a nonsymmetrical elongated hexagon shape, and wherein a front portion of the hexagon shape is elongated compared to a back portion of the hexagon shape.

14. The flatbed cart of claim 10, wherein the tray is pivotally engaged with the frame.

15. The flatbed cart of claim 10, wherein the first wall has a curved outer portion.

16. A flatbed cart comprising:
a frame having a first side portion, a second side portion, and a central front portion, wherein the central front portion positioned between a the first side portion and the second side portion, wherein the frame has a first end on the first side portion and a second end on the second side portion, wherein the first side portion extends from the first end downward and backward along a curved surface before moving forward toward the central front portion;
a tray including an outer frame with a wire mesh between sides of the outer frame, wherein the tray is pivotally attached to the frame and has a nonsymmetrical elongated hexagon shape, and wherein a front portion of the hexagon shape is elongated compared to a back portion of the hexagon shape;
a handle extending between the first side portion and the second side portion opposite the central front portion, wherein the handle has a portion extending rearward from the frame; and
a caster lift system extending between the first side portion of the frame and the second side portion of the frame, wherein the caster lift system includes a cart engagement portion and a ramp portion, wherein the ramp portion angles downward and away from the cart engagement portion.

17. The flatbed cart of claim 16, wherein the handle comprises a primary handle portion, a secondary handle portion, and two connection portions, wherein the handle is engaged with the frame at the two connection portions.

18. The flatbed cart of claim 17, wherein the secondary handle portion extends rearward from a lower portion of each of the two connecting portions.

19. The flatbed cart of claim 16, wherein when a second cart is pushed into a rear of the flatbed cart, the second cart rides up the ramp portion and the second cart rests on the caster lift system such that forward casters of the second cart are lifted.

20. The flatbed cart of claim 16, further comprising an anti-wear component formed from wire attached to a lower portion of the frame, wherein the anti-wear component has a portion extending beyond an outer surface of the frame.
